(19) United States
(12) Patent Application Publication
(10) Pub. No.: US 2021/0053861 A1
(43) Pub. Date: Feb. 25, 2021

(54) A METHOD AND A DEVICE FOR GENERATING A SEQUENCE OF CUTTING PLANS FOR CUTTING OUT A SEQUENCE OF GLASS PIECES IN A SEQUENCE OF GLASS SHEETS

(71) Applicant: SAINT-GOBAIN GLASS FRANCE, COURBEVOIE (FR)

(72) Inventors: Maxime VAN LANDEGHEM, FONTENAY SOUS BOIS (FR); Laurent VILAIN, CHATENAY MALABRY (FR)

(21) Appl. No.: 16/955,630

(22) PCT Filed: Dec. 19, 2018
(86) PCT No.: PCT/EP2018/085982

§ 371 Date: Jun. 18, 2020

(30) Foreign Application Priority Data
Dec. 21, 2017 (FR) 1762724

(51) Int. Cl. C03B 33/037; B26D 5/00; G05B 19/402

(52) U.S. Cl. CPC C03B 33/037; G05B 2219/37087; G05B 19/402; B26D 5/005

(57) ABSTRACT

A method for generating a sequence of cutting plans for cutting out a sequence P of glass pieces in a sequence F of glass sheets, the glass pieces to be stacked according to order and/or positioning requirements on one or more stands Cₖ, includes retrieving information relating to the location and nature of faults in each of the glass sheets of the sequence F; defining an optimization criterion σ; generating, implemented by computer, of one or more sequences Sᵢ of cutting plans PDᵢⱼ for the glass sheets according to the location of the faults in each of the glass sheets and while satisfying the order and/or positioning requirements of the glass pieces for each stand Cₖ; selecting, implemented by computer, of one of the sequences Sᵢ of cutting plans PDᵢⱼ according to the optimization criterion σ.

The present invention relates to a method for generating a sequence of cutting plans for cutting out a sequence of glass pieces in a sequence of glass sheets. The invention relates also to a device for generating a sequence of cutting plans for implementing such a method.

Flat glass is generally produced continuously in the form of a ribbon from which plates or sheets of glass of finite dimensions are cut out, usually of large dimensions generally not exceeding 9 m×4 m. “Jumbo” size glass sheets (6 m×3.21 m) are examples of glass sheets that can be cut out from the ribbon.

These glass sheets of large dimension are not generally used as such. After production, they are often cut into pieces, generally rectangular, of smaller dimensions and adapted to the needs of the customer or to the specifications required for later conversion steps. The glass pieces are cut from the glass sheet according to a cutting plan defined beforehand. This satisfies possible order and positioning requirements according to which the glass pieces are intended to be stacked on stands. Very simply, a cutting plan can be considered to be a mosaic of the glass sheet by geometric shapes, generally rectangular and of different sizes, representing the pieces to be cut out and arranged in such a way as to reduce the total surface area of offcuts, i.e. the non-usable surface area at the cutout.

The glass sheets from which the pieces are cut out can also include faults. These faults must be excluded from the pieces to be cut out. It is therefore necessary to adapt the cutting plan in such a way that the faults are located in the offcuts.

The document US2005023337 A1 discloses a method for cutting out glass pieces from a continuously produced glass ribbon. In order to be implemented, this method presumes preliminary knowledge about the pieces to be cut out before the cutting operation in order that the cutting plan is continuously adapted according to the location of the faults detected on the glass ribbon. This method provides for only cutting out pieces according to cutting plans corresponding to mosaics of pieces in the same direction with a limited number of choices of cutting lines. It generates a number of offcuts. Moreover, it is not applicable to cutting out pieces of glass from glass sheets.

In most installations, the glass sheets are stored, often stacked, before being cut later at a converter and/or at an appropriate time upon a customer order. In other words, the producer of the glass sheets does not in principle have knowledge of the pieces to be cut nor of the tolerance with which any faults in the glass sheet can be taken into account by the converter. In these situations, the glass pieces are cut later in a batch comprising a certain sequence of glass sheets to which the cutting plan or plans of said pieces must be adapted in order to take account of the faults that they contain.

The document WO 2014128424 A1 discloses a cutting method in which the cutting plan for each sheet is adapted, “on-the-fly”, at the moment when the glass sheet is extracted. The nature and location of the faults that it contains are known only at the moment of extraction. In this method, the cutting plan is optimized with the aid of an algorithm which explores the space of possible permutations of the pieces to be cut so as to place the faults in the offcuts. When this is impossible, the faults are placed in the smallest pieces or areas of pieces intended to be masked when they are assembled.

Now, it is cutting plans which do not allow such “on-the-fly” optimization. For example, no fault can be tolerated in the pieces, even the smallest ones, or no permutation provides for placing the faults in the smallest pieces or in areas of pieces likely to be masked. In that case, the pieces produced are lost. They must be recut, often immediately, from the next glass sheet in order to satisfy the order and positioning requirements of the stand on which it must be stacked. Consequently, the cutting plans for the next glass sheets must be modified to incorporate the missing pieces, these cutting plans having themselves to be adapted to any faults that the glass sheets include. This can cause a cascade of changes in the sequence of cutting plans and result in significant losses of time and glass.

The present invention solves these problems. It relates to a method for generating a sequence of cutting plans for cutting out a sequence P of glass pieces from a sequence F of glass sheets, said glass pieces being intended to be stacked according to order and/or positioning requirements on one or more stands Cₖ, said method comprising the following steps:
a. the retrieval of information relating to the location and nature of faults in each of the glass sheets of the sequence F;
b. the definition of an optimization criterion σ;
c. the generation, implemented by computer, of one or more sequences Sᵢ of cutting plans PDᵢⱼ for glass sheets according to the location of the faults in each of the glass sheets and while satisfying the order and/or positioning requirements of the glass pieces for each stand Cₖ;
d. the selection, implemented by computer, of one of the sequences Sᵢ of cutting plans PDᵢⱼ according to the optimization criterion σ.

The advantage of the method of the invention is that it anticipates the presence of faults possibly present in the glass sheets while taking them into consideration at the time of the generation of the cutting plans and not later. The method of the invention provides for gaining time and reducing glass losses at the time of cutting. Specifically it provides for generating only one sequence of cutting plans for the cutting out the whole of the sequence of pieces and consequently avoids modifying the cutting plans when the glass sheets are extracted in order to take into account faults that they can exhibit. The result is an increase in production yield with almost all faults eliminated. Those faults are advantageously placed in the glass offcuts which are inevitably and insurmountably linked to the requirements imposed during cutting.

In a particular embodiment of the invention, the order and/or positioning requirements are chosen from among the orientation of the glass pieces in each stand Cₖ and/or the order of the glass pieces in each stand Cₖ. The order and/or positioning requirements of glass pieces for each stand Cₖ are generally defined by the specifications of the customers for whom the cut pieces are intended. The pieces can be ordered and positioned according to the characteristics of the methods used by the customers for their possible conversion or assembly. The advantage for customers is a reduction in the steps for handling the pieces, and therefore breakage risks associated with this handling. By way of illustrative and nonlimiting example, on the same stand, certain pieces, generally of different sizes, can be placed in portrait mode and others in landscape mode in a certain order.

In the method of the invention, several sequences Sᵢ of cutting plans PDᵢⱼ can be generated for the same order and/or positioning requirements of the glass pieces for each stand Cᵢ. The optimization criterion σ can hence be chosen so as to select the one which contributes to the most significant reduction in glass losses. In a particular embodiment of the invention, the optimization criterion σ is chosen from among a criterion of minimum total surface area loss or a criterion of minimum number of glass sheets cut.

The sequence or sequences Sᵢ of cutting plans PDᵢⱼ for the sheets can also be generated according to cutting requirements of the glass pieces for each stand Cₖ. For example, the cutting can be a cutting by guillotine. In that case, the cutting plans can include several hierarchical cutting levels. These hierarchical levels correspond to orders and directions according to which the cutouts are produced depending on the type of cutting used. For example, cutting by guillotine generally crosses the whole of the glass sheet from end to end, parallel to one of its edges. The order and orientation according to which the pieces are cut in a cutting plan must enable the use of such a cutting method while minimizing offcuts.

The faults that the glass sheets can possibly include generally differ in nature and size. According to the applications which each of the glass pieces are aimed at, certain faults can be tolerated in said pieces. In one embodiment of the invention, the generation of the sequence or sequences Sᵢ of cutting plans PD_{i,j} for the glass sheets is carried out such that glass pieces to be cut contain faults satisfying a severity criterion Ψ defined beforehand.

The severity criterion Ψ can be defined according to the final application which the glass pieces are aimed at. This criterion can then correspond to fixed threshold values for one or more characteristics of faults, and below which these faults have little impact for this application. For example, the same fault having a given size can be tolerated for use of the glass pieces as glazing for a building but not be tolerated for use as glazing for a vehicle. The severity criterion is therefore generally defined on the basis of the specifications of the customers for whom the pieces are intended. In particular, the severity criterion Ψ is chosen from among a fault size criterion, a criterion of fault density on the glass sheet, a fault nature criterion or an optical alteration criterion, alone or in combination.

For certain applications, it is preferable that the glass pieces are devoid of any fault. In a particular embodiment of the method of the invention, the sequence or sequences Sᵢ of cutting plans PD_{i,j} for the glass sheets are generated such that all the faults are placed in the glass offcuts, outside the pieces to be cut.

The steps (c) and (d) of the method of the invention are implemented by computer. The invention also relates to a computer program comprising instructions for the execution of the steps of the method for generating a sequence of cutting plans according to the invention in all possible embodiments. The steps of the method can be implemented using any type of programming language compiled to a binary form or directly interpreted in the form of arithmetic or logic instructions that can be executed by a computer or any programmable information processing system. The computer program can form part of an item of software, i.e. a set of executable instructions and/or one or more datasets or databases.

The instructions of the computer program can implement the method of the invention with the aid of several types of algorithm. In particular, the generation of the sequences Sᵢ of cutting plans PDᵢⱼ of step (c) and/or the selection of one of the sequences Sᵢ of cutting plans PDᵢⱼ of step (d) are carried out with the aid of an exploratory dendrogram, a heuristic or metaheuristic search method, linear optimization by Lagrange duality, or dynamic programming.

When the number of pieces to be cut in the glass sheet sequence F is particularly high, the time required to generate one or more sequences Sᵢ of cutting plans PDᵢⱼ can be relatively long and not very compatible with the production rates. In such a case, it can be advantageous for the duration required for executing the step for generating the sequence or sequences Sᵢ of cutting plans PDᵢⱼ for the glass sheets not to exceed a predefined duration. Said duration can in particular be predefined to meet the requirements of a production schedule. At the end of the time period defined by this duration, the method can select the sequence of cutting plans which satisfies to the greatest degree the optimization criterion from among the sequences generated.

The invention also relates to a storage medium readable by computer on which there is recorded a computer program comprising instructions for executing the steps of the method for generating a sequence of cutting plans according to the invention. The storage medium is preferably a non-volatile or permanent computer memory, for example a magnetic mass memory or a semiconductor mass memory (solid state drive, flash memory). It can be removable or integrated in the computer which reads its contents and execute its instructions.

The retrieval of information of step (a) can comprise the reading, with the aid of an acquisition means, of a symbol forming a code able to be read via the edge face of each of the glass sheets, said code containing an identifier associated with the information relating to location and nature of the faults in the glass sheet. Examples of symbols forming a code that can be read via the edge face are described in the document WO 2015/121548 A1.

In order to be readable via the edge face of the glass sheet, the symbol, generally two-dimensional, is marked within the thickness of the glass sheet, sometimes at different depths. Examples of acquisition means are described in the document WO 2015/121549 A1. They often comprise a camera acquiring an image of the symbol via the edge face of the glass sheet and a system for processing the acquired image in order to extract the identifier encoded in the symbol.

In one embodiment of the method according to the invention, the identifier is contained in a database which contains the information relating to the location and nature of the faults in the glass sheet. The database can, for example, be accessible from the storage medium of a server computer on which the database is saved and with which a client computer is telecommunicating. Using an appropriate telecommunication protocol, the client computer transmits the identifier to the server computer which in response transmits the information relating to the location and nature of the faults in the glass sheet required to execute the next steps in the method. The database can advantageously be hosted at the manufacturer of the glass sheets. Thus, retrieval of the information contained in the database is simplified since it can be carried out in any place where the method of the invention can be used and comprising a telecommunication means with the server computer of the manufacturer of the glass sheets.

In a particular embodiment of the invention, the storage medium readable by computer on which the computer program comprising instructions for the execution of the steps of the method of the invention is recorded is integrated in the same computer as that on which the database containing the information relating to the location and nature of the faults is hosted. Said computer can be a server computer located at the manufacturer of the glass sheets.

In another particular embodiment of the method of the invention, steps (a), (b) and/or (c) can advantageously and directly be implemented according to a cloud computing model. For example, at the place where the method of the invention is used, a client computer transmits the identifiers obtained by the reading of the visible codes via the edge faces of the glass sheets to a server computer with the aid of an appropriate telecommunication means. The server computer retrieves the information relating to the location and nature of the faults that the glass sheets can comprise by consulting said database, executes a computer program comprising instructions for the execution of steps (b) and (c) of the method and transmits the cutting plan sequence selected according to the optimization criterion at the client computer. The sequence of glass sheets can then be cut in accordance with this sequence of cutting plans. This embodiment enables computing resources to be shared between operators using the method of the invention. The operators are advantageously exempt from having a local computing infrastructure to implement the method of the invention.

The invention also relates to a cutting method comprising a method for generating a sequence of cutting plans as described previously, then a step (e) for cutting out glass pieces in the glass sheets according to the sequence Sᵢ of cutting plans PDᵢⱼ, which sequence is selected at step (d) of said generation method. Steps (a), (b) and (c) may or may not be implemented on the site where the glass sheets are cut. By way of example, this cutting step can be cutting by guillotine.

The invention also relates to a device for generating a sequence of cutting plans for cutting out a sequence P of glass pieces in a sequence F of glass sheets, each of the glass pieces being intended to be stacked according to order and/or positioning requirements on one or more stands Cᵢ, said device comprising the following modules:
a. a module for retrieving information relating to the location and nature of the faults in each of the glass sheets of the sequence F;
b. a module for defining an optimization criterion σ;
c. a module for generating one or more sequences Sᵢ of cutting plans PDᵢⱼ for glass sheets according to the location of the faults in each of the glass sheets and satisfying the order and/or positioning requirements of the glass pieces for each stand Cₖ;
d. a module for selecting one of the sequences Sᵢ of cutting plans PDᵢⱼ according to the optimization criterion σ.

The modules of the device can comprise one or more calculation units. Calculation units are contained in the central processing units. The central processing units are generally integrated in computers which also contain a set of other electronic components, such as input-output interfaces, volatile and/or nonvolatile storage systems and buses needed to transfer data between the central processing units and upon communication with external systems, in this case the various modules.

In one embodiment of the device of the invention, (Rev16) the module for retrieving information relating to the location of faults in each of the glass sheets of the sequence F is a module for reading a symbol forming a code able to be read via the edge face of each of the glass sheets, said code containing an identifier associated with the information relating to the location and nature of the faults in the glass sheet.

The read module can comprise acquisition means such as those described in the document WO 2015/121549 A1. It often contains a camera acquiring an image of the symbol via the edge face of the glass sheet and a system for processing the acquired image in order to extract the identifier encoded in the symbol. The processing system can be a computer comprising software suitable for processing this type of image.

The device for generating a sequence of cutting plans can additionally comprise a module for direct or indirect telecommunication with a storage medium readable by computer containing a database containing, for each identifier, the information relating to the location of faults in each glass sheet of the sequence F. This telecommunication module can be physical or virtual. The storage medium can be integrated in a server computer which the retrieval module accesses via the telecommunication module to retrieve the information relating to the location of the faults in the glass sheets.

In another particular embodiment of the device of the invention, the definition, generation and selection modules can be modules integrated in a cloud computing infrastructure. They can be integrated in a computer network with which the retrieval module is telecommunicating. This retrieval module can comprise a client computer transmitting the identifiers obtained by the reading of the visible codes via the edge faces of the glass sheets to a server computer serving as access gateway to said network. The server computer can retrieve information relating to the location and nature of the faults that the glass sheets can contain by consulting said database, possibly hosted on the storage space of another computer, and transmit this information to the definition, generation and selection modules for the execution of steps (b) and (c) of the cutting method. The computer then transmits the sequence of cutting plans, which sequence is selected according to the optimization criterion at the client computer. The sequence of glass sheets can then be cut in accordance with this sequence of cutting plans.

In a particular embodiment of the device of the invention, the retrieval, definition, generation and selection modules are virtual modules. By way of example, they can be modules instantiated in the form of objects by a computer program or computer software from classes in the random access memory, possibly assisted by virtual memory, of a computer. The computer can comprise several central processing units, storage media and input-output interfaces.

The device for generating a sequence of cutting plans according to the invention can be contained in a device for cutting out glass pieces. The cutting device hence comprises a device for generating a sequence of cutting plans as described previously and a module for cutting out glass pieces in the glass sheets according to the selected sequence Sᵢ of cutting plans PDᵢⱼ. This cutting module can in particular be a module for cutting by guillotine.

The features of the invention are illustrated by the drawings described hereafter.

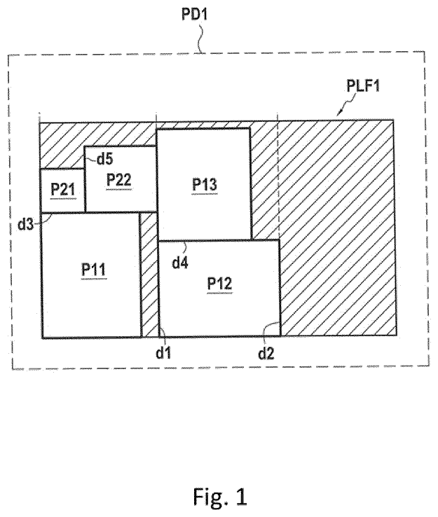

FIG. 1 is a schematic representation of an example cutting plan for a glass sheet.

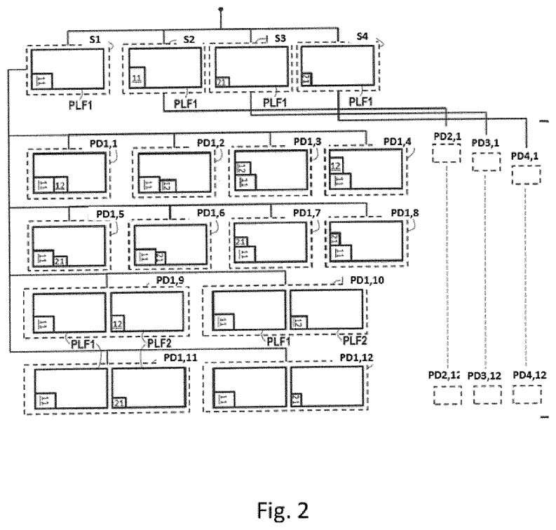

FIG. 2 is a graphic representation, in the form of a logic diagram, of several sequences Sᵢ of cutting plans PDᵢⱼ for sheets, satisfying the order and positioning requirements of the glass pieces for each stand Cₖ.

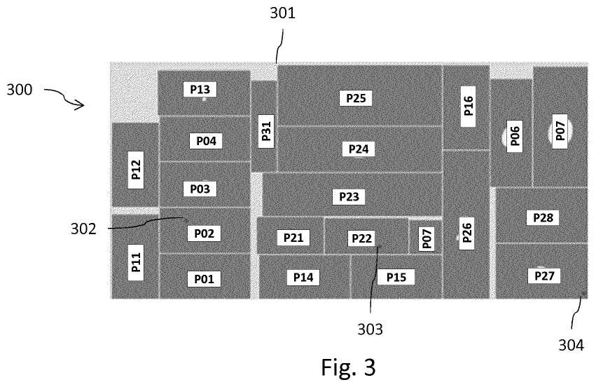

FIG. 3 is a schematic representation of an example cutting plan obtained using a method without cutting optimization.

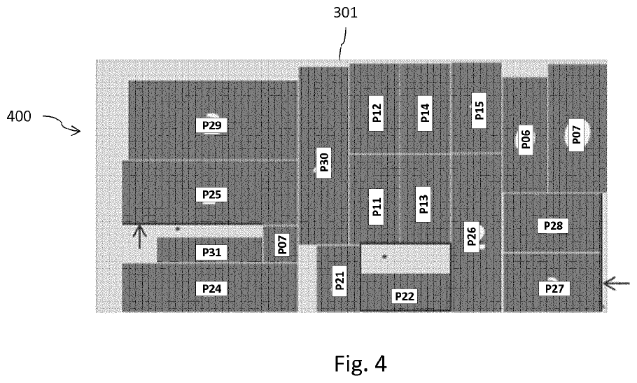

FIG. 4 is a graphic representation of an example cutting plan obtained using the method according to the invention.

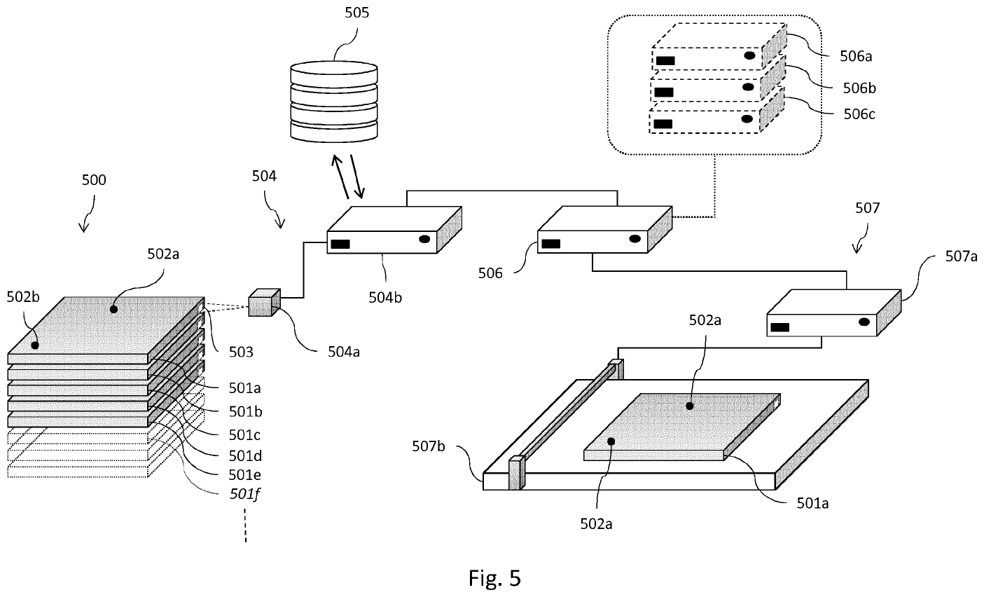

FIG. 5 is a schematic representation of a first embodiment of the cutting device according to the invention.

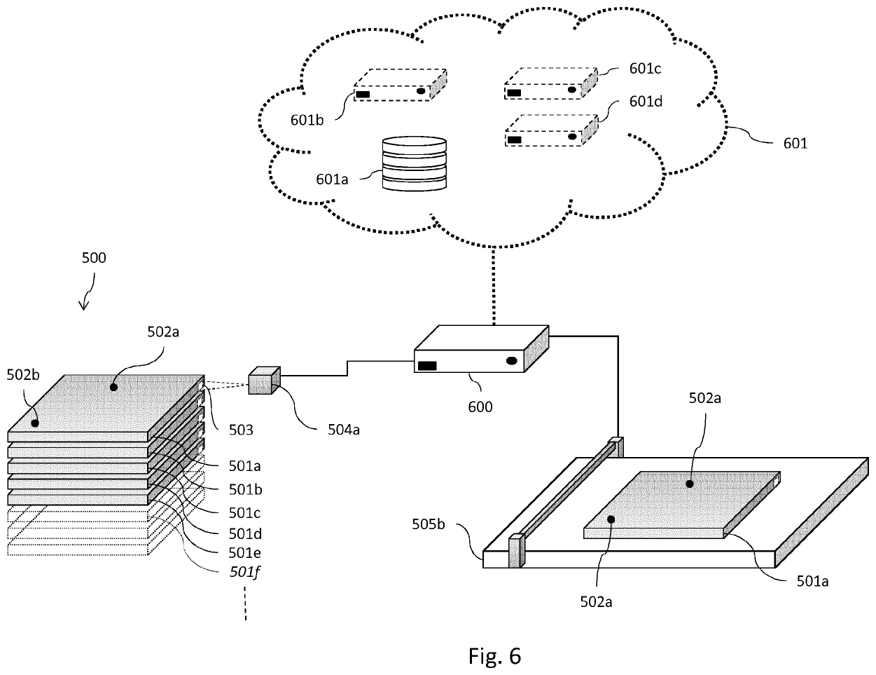

FIG. 6 is a schematic representation of a second embodiment of the cutting device according to the invention.

An example cutting plan PD1 for a glass sheet PLF1 is schematically represented in FIG. 1. This plan provides for cutting out five pieces of glass P11, P12, P13, P21 and P22 with three hierarchical cutting levels: two cutouts d1 and d2 of hierarchical level 1, two cutouts d3 and d4 of hierarchical level 2, and a cutout d5 of hierarchical level 3.

In FIG. 2, there is represented a simplified example of the generation of several sequences Sᵢ of cutting plans PDᵢⱼ for cutting out three pieces 11, 12 and 21 in a sequence of two glass sheets PLF1 and PLF2 according to the location of the faults (not represented) and while satisfying the order, positioning and cutting requirements for the glass pieces for each stand Cₖ. In this example, the four sequences S₁ to S₄ each contain 12 cutting plans, PD_{1,1} to PD_{4,12}. For the purposes of readability of the drawing, only the cutting plans PD_{1,1} to PD_{1,12} are represented, and the cutting plans PD_{2,1} to PD_{4,12} of the sequences S₂ to S₄ are represented by dotted-line rectangles.

The sequences are obtained using an exploratory dendrogram. A first sequence Sᵢ is generated by first of all placing a first piece 11 on the lower lefthand edge of the first glass sheet PLF1 according to a first orientation. Next, a second piece 12 is placed according to two possible orientations in contact with the two free edges of the first piece 11 in order to construct four cutting plans PD_{1,1} to PD_{1,4}. The same operation is carried out for the piece 21 by substituting it for the piece 12 in order to construct four other cutting plans PD_{1,5} to PD_{1,8}. The construction is continued with the third piece 21 for the cutting plans PD_{1,1} to PD_{1,4} or the third piece 12 for the cutting plans PD_{1,5} to PD_{1,8}. The cutting plans obtained are not represented in the drawing.

Alternatively, the pieces 12 and 21 are placed on the lower lefthand edge of the second glass sheet PLF2 according to two orientations in order to construct the cutting plans PD_{1,9} to PD_{1,10} and PD_{1,11} to PD_{1,12}. The construction of the cutting plans is continued with the third remaining piece according to the same method.

The sequence S₂ is generated according to the same method from the first piece 11 placed in a second direction on the lower lefthand edge of the glass sheet PLF1. Likewise, the same method is used to generate the sequences S₃ and S₄ by replacing the piece 11 by the piece 21 as first piece.

At the end of the generation of the sequences, the sequence of cutting plans that satisfies the optimization criterion σ is selected.

An example cutting plan 300 for a glass sheet 301 and obtained using a method without cutting optimization is represented in FIG. 3. This method does not take into account faults 302, 303 and 304 present in the glass sheet when the cutting plan is generated. These faults 302, 303 and 304 are located in pieces P02, P22 and P27 respectively. After cutting, these pieces are unusable and must be recut in the next glass sheet. This causes a cascade of changes in the sequence of cutting plans and results in significant losses of time and glass.

FIG. 4 schematically represents a cutting plan 400 obtained using the method according to the invention for the glass sheet 301 of FIG. 3. By taking into account the faults before the cutting plan is generated, the latter can be optimized so as to place these faults in the offcuts. With reference to FIG. 4, certain pieces have been replaced by others, while satisfying the order and/or positioning requirements of the glass pieces for each stand Cₖ. In particular, the pieces P01, P02, P03 and P04 have been removed and replaced by the pieces P29 and P30 which are compatible with the order and/or positioning requirements.

An example of a first embodiment of a cutting device according to the invention is schematically represented in FIG. 5. It comprises a module 504 for retrieving information relating to the location of faults, 502a and 502b, in each of the glass sheets, 501a, of a sequence 500 of glass sheets 501a-501f. This module comprises a read module, for example a camera 504a, which reads a symbol forming a code 503 on the edge face of each of the glass sheets, 501a. This code 503 is transmitted to a processing system 504b for the code image acquired by the camera. The system extracts the identifier encoded in the symbol and retrieves the information relating to the location and nature of the faults 502a and 502b in the glass sheet 501a by consulting a database 505 which contains this identifier.

This information is then transmitted to a computer 506 which contains the following modules:
a module 506a for defining an optimization criterion σ;
a module 506b for generating one or more sequences Sᵢ of cutting plans PDᵢⱼ for the glass sheets according to the location of the faults in each of the glass sheets and satisfying the order and/or positioning requirements of the glass pieces for each stand Cₖ;
a module 506c for selecting one of the sequences Sᵢ of cutting plans PDᵢⱼ according to the optimization criterion σ.

These modules are instantiated in the form of objects by a computer program or computer software from classes in the random access memory, possibly assisted by a virtual memory, of the computer 506.

The selected sequence Sᵢ of cutting plans PDᵢⱼ is transmitted to a cutting module 507 comprising a cutting table 507b and a computer 507a for controlling the cutting table. The computer 507b sends instructions to the cutting table in order to cut the sequence 500 of glass sheets according to the selected sequence Sᵢ of cutting plans PDᵢⱼ. By way of illustrative example, only the glass sheet 501a is represented on the cutting table. The cutting plan is not represented.

FIG. 6 schematically represents a second embodiment of the cutting device according to the invention. This device differs from that of FIG. 5 by the fact that the computers 504b, 506 and 507 are replaced by a single computer 600 telecommunicating with a cloud computing infrastructure 601. This infrastructure contains:
a database 601a containing information relating to the location and nature of the faults in each of the glass sheets of the sequence 500;
a module 601b for defining an optimization criterion σ;
a module 601c for generating one or more sequences Sᵢ of cutting plans PDᵢⱼ for the glass sheets according to the location of the faults in each of the glass sheets and satisfying the order and/or positioning requirements of the glass pieces for each stand Cₖ;
a module 601d for selecting one of the sequences Sᵢ of cutting plans PDᵢⱼ according to the optimization criterion σ.

The read module, for example a camera 504a, reads a symbol forming a code 503 on the edge face of each of the glass sheets, for example 501a. This code 503 is transmitted to a processing system 600 for the code image acquired by the camera. The system extracts the identifier encoded in the symbol and transmits it to the cloud 601. Once extracted from the database 601a by virtue of the identifier, the information relating to the location and nature of the faults 502a and 502b in the glass sheet 501a is transmitted to the generation module 601c. The sequence Sᵢ of cutting plans PDᵢⱼ that is selected by the module 601d is then transmitted to the computer 600. The latter conveys instructions to the cutting table in order to cut the sequence 500 of glass sheets according to the selected sequence Sᵢ of cutting plans PDᵢⱼ. By way of illustrative example, only the glass sheet 501a is represented on the cutting table. The cutting plan is not represented.

This embodiment is advantageous since it enables computing resources to be shared between operators using the method of the invention. They are thus exempt from having a local computing infrastructure.

1. A method for generating a sequence of cutting plans for cutting out a sequence P of glass pieces in a sequence F of glass sheets, said glass pieces being intended to be stacked according to order and/or positioning requirements on one or more stands Cₖ, said method comprising:
a. retrieving information relating to the location and nature of faults in each of the glass sheets of the sequence F;
b. defining an optimization criterion σ;
c. generating, implemented by computer, one or more sequences Sᵢ of cutting plans PDᵢⱼ for the glass sheets according to the location of the faults in each of the glass sheets and while satisfying the order and/or positioning requirements of the glass pieces for each stand Cₖ;
d. selecting, implemented by computer, one of the sequences Sᵢ of cutting plans PDᵢⱼ according to the optimization criterion σ.

2. The method for generating a sequence of cutting plans as claimed in claim 1, wherein the optimization criterion σ is chosen from among a criterion of minimum total surface area loss or a criterion of minimum number of glass sheets cut.

3. The method for generating a sequence of cutting plans as claimed in claim 1, wherein the order and/or positioning requirements are chosen from among the orientation of the glass pieces in each stand Cₖ and/or the order of the glass pieces in each stand Cₖ.

4. The method for generating a sequence of cutting plans as claimed in claim 1, wherein the cutting plans comprise several hierarchical cutting levels.

5. The method for generating a sequence of cutting plans as claimed in claim 1, wherein the generation of the sequence or sequences Sᵢ of cutting plans PDᵢⱼ for the glass sheets is carried out such that glass pieces to be cut contain faults satisfying a severity criterion Ψ defined beforehand.

6. The method for generating a sequence of cutting plans as claimed in claim 5, wherein the severity criterion Ψ is chosen from among a fault size criterion, a criterion of fault density on the glass sheet, a fault nature criterion or an optical alteration criterion, alone or in combination.

7. The method for generating a sequence of cutting plans as claimed in claim 1, wherein the generation of sequences Sᵢ of cutting plans PDᵢⱼ of step (c) and/or the selection of one of the sequences Sᵢ of cutting plans PDᵢⱼ of step (d) are carried out with the aid of an exploratory dendrogram, a heuristic or metaheuristic search method, linear optimization by Lagrange duality, or dynamic programming.

8. The method for generating a sequence of cutting plans as claimed in claim 1, the wherein a duration required for executing the step for generating the sequence or sequences Sᵢ of cutting plans PDᵢⱼ for the glass sheets does not exceed a predefined duration.

9. The method for generating a sequence of cutting plans as claimed in claim 1, wherein the information retrieval of step (a) comprises the reading, with the aid of an acquisition system, of a symbol forming a code able to be read via the edge face of each of the glass sheets, said code containing an identifier associated with the information relating to the location and nature of the faults in the glass sheet.

10. The method for generating a sequence of cutting plans as claimed in claim 9, wherein said identifier is contained in a database which contains the information relating to the location and nature of the faults in the glass sheet.

11. The method for generating a sequence of cutting plans as claimed in claim 1, wherein steps (a), (b) and (c) are implemented according to a cloud computing model.

12. A cutting method comprising carrying out a method for generating a sequence of cutting plans as claimed in claim 1, then (e) cutting out glass pieces in the glass sheets according to the sequence Sᵢ of cutting plans PDᵢⱼ that is selected at step (d) of said generation method.

13. A computer program comprising instructions for the execution of the steps of the method for generating a sequence of cutting plans as claimed in claim 1.

14. A non-transitory storage medium readable by computer on which there is recorded a computer program comprising instructions for executing the steps of the method for generating a sequence of cutting plans as claimed in claim 1.

15. A device for generating a sequence of cutting plans for cutting out a sequence P of glass pieces in a sequence F of glass sheets, each of the glass pieces being intended to be stacked according to order and/or positioning requirements on one or more stands Cₖ, said device comprising the following modules:
a. a module for retrieving information relating to the location and nature of faults in each of the glass sheets of the sequence F;
b. a module for defining an optimization criterion σ;
c. a module for generating one or more sequences Sᵢ of cutting plans PDᵢⱼ for the glass sheets according to the location of faults in each of the glass sheets and satisfying the order and/or positioning requirements of the glass pieces for each stand Cₖ; and
d. a module for selecting one of the sequences Sᵢ of cutting plans PDᵢⱼ according to the optimization criterion σ.

16. The device for generating a sequence of cutting plans as claimed in claim 15, wherein the module for retrieving information relating to the location of faults in each of the glass sheets of the sequence F is a module for reading a symbol forming a code able to be read via the edge face of each of the glass sheets, said code containing an identifier associated with the information relating to the location and nature of the faults in the glass sheet.

17. The device for generating a sequence of cutting plans as claimed in claim 16, further comprising a module for direct or indirect telecommunication with a storage medium readable by computer containing a database containing, for each identifier, the information relating to the location of faults in each glass sheet of the sequence F.

18. A cutting device comprising a device for generating a sequence of cutting plans as claimed in claim 15, and a module for cutting out glass pieces in the glass sheets according to the selected sequence Sᵢ of cutting plans PDᵢⱼ.
